(19) United States
(12) Patent Application Publication
(10) Pub. No.: US 2026/0139761 A1
(43) Pub. Date: May 21, 2026

(54) VALVE TIGHTENING ASSEMBLY FOR MULTIPORT ROTARY VALVES

(71) Applicant: ILiAD IP COMPANY, LLC, Carlsbad, CA (US)

(72) Inventor: Steven Michael HERNANDEZ, Belleville, WI (US)

(73) Assignee: ILiAD IP COMPANY, LLC, Carlsbad, CA (US)

(21) Appl. No.: 19/395,597

(22) Filed: Nov. 20, 2025

Related U.S. Application Data
(60) Provisional application No. 63/723,208, filed on Nov. 21, 2024.

(51) Int. Cl. F16K 37/00; F16K 11/085; F16K 31/04

(52) U.S. Cl. CPC F16K 37/0083; F16K 11/0856; F16K 31/043

(57) ABSTRACT

The invention relates to a valve tightening assembly for multiport rotary valves, addressing challenges in maintaining consistent compression and sealing performance under varying operational conditions. The assembly includes a linear or rotary actuator, a force or weight sensor (e.g., load cell) for measuring clamping force, and a control system configured to dynamically adjust the clamping force based on real-time feedback. The actuator assembly interacts with tensioning rods to apply axial compressive force to the valve body, ensuring proper sealing and minimizing leakage. The control system compares load cell signals to a predetermined setpoint and commands the actuator to extend, retract, or rotate to achieve optimal compression. Applications include fluid transport in direct lithium extraction processes, where precise sealing is of significant importance. The assembly reduces manual intervention, enhances sealing longevity, and improves operational efficiency by compensating for temperature and pressure fluctuations.

### CROSS-REFERENCE TO RELATED APPLICATIONS

This application claims the benefit of United States Provisional Ser. No. 63/723,208 filed Nov. 21, 2024, and incorporates said provisional application by reference in its entirety into this document as if fully set out at this point.

### BACKGROUND OF THE INVENTION

### 1. Field of the Invention

The present disclosure pertains to valve systems, specifically to a valve tightening assembly for multiport rotary valves designed to improve compression and sealing performance.

### 2. Description of the Related Art

Fluid transport and treatment processes regularly rely upon valve systems to control fluid flow. For example, different valve routes may be used in a multiport valve to direct process liquids to specific stages or zones. A multiport rotary valve can be used for continuous countercurrent ion exchange or adsorption and desorption of lithium-bearing feedstocks in direct lithium extraction processes. The rotary valve drives a rotating process disc seated in a valve housing/body using a motor, and fluid flow through the valve is controlled by flow mapping of the process disc. The process disc is sealed within the valve body using one or more seals to provide sealing across the multiple process flow channels. The valve body is fastened and compressed using one or more bolts or tensioning rods. For example, thread rods and nuts may be placed around the perimeter of the valve body to compress the valve body against the process disc, thereby achieving sealing.

Thermal fluctuations in ambient and process temperatures, as well as the heating up and cooling down of the valve body during operation, may cause the tensioning rods to tighten and loosen in an undesirable, uncontrollable manner. This variation of the tensioning rods can lead to leaks at the seals of internal ports (crossflow) or the leak detection ports on the exterior of the valve. Initial process sealing of the valve, achieved by adjusting the tensioning rods, is also a manual action and is affected by variations in ambient and process temperatures. Overtightening the tensioning rods to compensate for these changes can cause excess wear on internal seals and mating surfaces of the rotary valve, as well as increased strain on the motor(s) and gearbox(es). The leakage and wear caused by tension fluctuations of the valve body reduce the fluid flow efficiency and overall efficiency of the extraction process, increasing maintenance interventions and long-term operating costs.

Although manual adjustments may be made to the tensioning rods, inconsistencies will likely be introduced when personnel manually tighten the valve body tensioning rods. Furthermore, it is challenging for personnel to determine the necessary adjustments at a given time to compensate for changes in the valve body. These challenges increase maintenance frequency, elevate operating costs, and impose safety concerns associated with unplanned leaks. As a result, there remains a need for a more controlled and consistent method of maintaining valve body compression that responds dynamically to changing process conditions without reliance on subjective manual intervention.

### SUMMARY OF THE INVENTION

Therefore, it is desirable to provide a valve tightening assembly for a multiport rotary valve to improve valve compression. The valve tightening assembly provides automatic monitoring and tightening of the valve to minimize internal crossflow and external leakage, alleviate the impact of temperature and pressure differentials on the valve, and prevent inconsistencies introduced by manual intervention.

In general, in a first aspect, the invention relates to a valve tightening assembly for a multiport rotary valve. The multiport rotary valve has a valve body with a tensioning assembly configured to apply an axial compressive force to the valve body. The tensioning assembly includes at least one tensioning rod axially extending through the valve body. The valve tightening assembly includes a force or weight sensor disposed about the tensioning rod and positioned adjacent to the valve body. The force or weight sensor is configured to produce a signal indicative of a clamping force applied to the valve body. The valve tightening assembly also includes an actuator assembly operatively coupled to the tensioning rod and configured to vary the clamping force applied to the valve body. A control system is operatively coupled to the force or weight sensor and to the actuator assembly, and is configured to compare the signal from the force or weight sensor to a predetermined setpoint and to command the actuator assembly to adjust the clamping force when the signal deviates from the predetermined setpoint.

In an embodiment, the actuator assembly is a linear actuator assembly or a rotary actuator assembly having electric, hydraulic, or pneumatic actuation.

In an embodiment, the linear actuator assembly includes a linear actuator body having an actuator channel, an actuator shaft configured for linear movement to and from the actuator channel, and a mechanism for converting linear movement of the actuator shaft into a change in clamping force on the valve body.

In an embodiment, the mechanism includes a central wedge attached to the actuator shaft, a first wedge block positioned above the central wedge, and a second wedge block positioned below the central wedge.

In an embodiment, the mechanism is attached to the tensioning rod such that extension of the actuator shaft creates the clamping force on the valve body.

In an embodiment, the mechanism has cam arms attached to the actuator shaft such that retraction of the actuator shaft rotates the cam arms to create the clamping force on the valve body.

In an embodiment, the mechanism has a fixture attached to the actuator shaft such that extension of the actuator shaft rotates the fixture about the tensioning rod to create the clamping force of the valve body.

In an embodiment, a brake is configured to hold the actuator shaft in place.

In an embodiment, the control system produces instructions to engage the brake when the signals produced by the force or weight sensor match the predetermined setpoint.

In an embodiment, the rotary actuator assembly has a motor, a motor shaft extending from the motor, a pinion gear fixed to the motor shaft, an arm attached to the tensioning rod, and a curved rack secured to the tensioning rod and meshing with the pinion gear. The rotation of the motor shaft affects the axial movement of the arm relative to the tensioning rod, thereby varying the clamping force.

In an embodiment, the valve body includes a housing ring defining an internal valve chamber, an upper closure disc and a lower closure disc secured to opposing axial ends of the housing ring, and a process disc rotatably received within the internal valve chamber.

In an embodiment, the multiport rotary valve has an annular seal or sealing assembly constructed of a low-friction polymeric material and disposed between a sidewall of the housing ring and a periphery of the process disc, and a plurality of concentric seals or sealing assemblies constructed of a low-friction polymeric material and disposed between axially confronting sealing surfaces of the process disc and the upper and lower closure discs.

In an embodiment, the control system is configured to selectively adjust the clamping force applied to or maintained on the valve body in response to real-time feedback obtained from the force or weight sensor during startup, operation, and/or cooldown of the multiport rotary valve.

In an embodiment, the force or weight sensor is one or more strain gauge load cells, capacitive load cells, pneumatic load cells, hydraulic load cells, piezoelectric load cells, inductive load cells, magnetostrictive load cells, optical fiber load cells, load washers, or a combination thereof.

In an embodiment, the valve tightening assembly also includes a position feedback device, such as one or more encoders, linear potentiometers, linear variable differential transformers, or a combination thereof.

In general, in a second aspect, the invention relates to a process for tightening a multiport rotary valve. The process includes engaging a valve tightening assembly with a valve body of the multiport rotary valve, obtaining signals representing a clamping force applied to the valve body from a force or weight sensor, comparing the clamping force to a predetermined setpoint, and adjusting the clamping force to match the predetermined setpoint.

In an embodiment, the step of adjusting the clamping force further comprises moving a shaft of the actuator assembly.

In an embodiment, the process also includes engaging a brake to maintain the clamping force.

In an embodiment, the adjusting step further includes selectively adjusting the clamping force applied to or maintained on the valve body in response to real-time feedback obtained from the force or weight sensor during startup, operation, and/or cooldown of the multiport rotary valve.

### BRIEF DESCRIPTION OF DRAWINGS

The above and other objects and advantages of this invention may be more clearly seen when viewed in conjunction with the accompanying drawing wherein:

FIG. 1 is an elevation view of an example of a multiport rotary valve constructed in accordance with an exemplary embodiment.

FIG. 2 is a perspective view of the multiport rotary valve shown in FIG. 1.

FIG. 3 is a cross-sectional view along lines A-A of FIG. 1.

FIG. 4 is a cross-sectional view along lines B-B of FIG. 1.

FIG. 5 depicts an example of a valve tightening assembly having a linear actuator assembly constructed in accordance with an exemplary embodiment in a fully retracted configuration.

FIG. 6A depicts a partial cutaway side view of the valve tightening assembly of FIG. 5 in the fully retracted configuration.

FIG. 6B depicts a partial cutaway side view of the valve tightening assembly of FIG. 6A in a fully extended configuration.

FIG. 7A depicts a top view of the valve tightening assembly of FIG. 6A in the fully retracted configuration.

FIG. 7B depicts a top view of the valve tightening assembly of FIG. 6B in the fully extended configuration.

FIG. 8 depicts another example of a valve tightening assembly having a linear actuator assembly constructed in accordance with an exemplary embodiment of the invention disclosed herein.

FIG. 9A depicts another example of a valve tightening assembly having a linear actuator assembly constructed in accordance with an exemplary embodiment in an extended configuration.

FIG. 9B depicts the valve tightening assembly of FIG. 9A in a retracted configuration.

FIG. 10A depicts another example of a valve tightening assembly having a linear actuator assembly constructed in accordance with an exemplary embodiment in a retracted configuration.

FIG. 10B depicts the valve tightening assembly of FIG. 10A in an extended configuration.

FIG. 11A depicts an example of a valve tightening assembly having a rotary actuator assembly constructed in accordance with an exemplary embodiment of the invention disclosed herein.

FIG. 11B depicts a top view of the valve tightening assembly of FIG. 11A.

FIG. 12 depicts a flowchart for a process of tightening a multiport rotary valve in accordance with an exemplary embodiment.

### DETAILED DESCRIPTION

The following detailed description provides illustrative embodiments of the described technology and is intended to be read in conjunction with the accompanying drawings. The described technology pertains to a valve tightening assembly for multiport rotary valves, which addresses challenges in maintaining consistent compression and sealing performance under varying operational conditions. While specific embodiments, configurations, and processes are described herein, it is important to note that these are provided for demonstration purposes only and are not intended to limit the scope of the described technology. The described technology may be implemented in various forms, arrangements, and modifications without departing from its principles and scope.

Certain well-known principles, components, and techniques commonly understood by those skilled in the art may not be described in extensive detail to avoid redundancy and maintain clarity. The examples provided herein are intended to demonstrate the functionality and advantages of the described subject matter, but are not to be construed as comprehensive or limited in application. Rearrangements, substitutions, or alterations of the described features and processes may be made without deviating from the scope of the claims, which define the boundaries of the described subject matter.

The global demand for lithium and other minerals necessary for advanced applications has driven the need for efficient extraction processes that can handle complex liquid feedstocks while achieving ultra-high purity outputs. Conventional fluid control systems, particularly multiport rotary valves, are integral to directing influent and effluent streams during continuous countercurrent adsorption and desorption operations. However, existing valve designs often suffer from significant limitations, including leakage, cross-contamination, and seal degradation under varying thermal and pressure conditions. These issues are intensified in direct lithium extraction (“DLE”) applications, where impurity removal requirements are stringent, and even minor seal failures can compromise downstream purification steps, reduce recovery rates, and increase operational costs. Additionally, conventional sealing mechanisms, such as O-rings, radial seals, and bolted compression assemblies, are prone to wear, distortion, and torque variability, necessitating frequent manual adjustments and maintenance, which further disrupt operational efficiency.

The present disclosure addresses these challenges by introducing a valve tightening assembly for use on multiport rotary valves where factors such as large temperature and pressure differentials, process disc eccentricity, or inconsistent body clamping forces might cause undesirable leakage. The multiport rotary valve is susceptible to fluid leakage if the valve is not properly compressed, resulting in an improper seal between the valve body and the process disc. The valve tightening assembly helps to optimize fluid flow through the valve body, as well as extend the life of both sealing and wear surfaces within the multiport rotary valve. By mitigating under-engagement (fluid crossover) and over-engagement (seal compression damage), the valve tightening assembly significantly improves extraction rates, reduces maintenance downtime, and enhances the overall reliability of the multiport rotary valve in DLE and mineral recovery applications.

The valve tightening assembly includes an actuator assembly that is in communication with a force or weight sensor or associated instrumentation to achieve controlled motion and accurate load measurement. The actuator assembly may provide either linear or rotary motion and incorporate motors (e.g., servo or stepper motors), mechanical linkages, and position feedback devices to enable precise positioning and closed-loop control. Position feedback devices can include encoders, linear potentiometers, linear variable differential transformers (LVDTs), or similar devices, enabling improved accuracy in motion profiles. Selection among electric, hydraulic, and pneumatic actuation may consider factors such as available power and utilities, cleanliness and leak tolerance, ambient and process temperature, required clamping force, dynamic response and duty cycle, fail-safe behavior in power-loss scenarios, and serviceability. The force or weight sensor may utilize a strain gauge, piezoelectric, capacitive, inductive, magnetostrictive, optical fiber, or other sensing technologies to monitor applied load during operation, ensuring consistent and reliable tightening performance. These benefits enable the valve assembly and the internal seals to operate with greater consistency and longer longevity under consistent compression, facilitated by the biasing provided by the valve tightening assembly.

Referring to the figures of the drawings, wherein like numerals of reference designate like elements throughout the several views, a valve tightening assembly 100 is illustrated for applying a static or dynamic clamping force to a multiport rotary valve 200. For purposes of illustration rather than limitation, the multiport rotary valve 200 is exemplified in connection with process fluid distribution and transport during continuous countercurrent adsorption and desorption (“CCAD”) processes, such as selective lithium and mineral recovery from natural and synthetic feedstocks. However, the multiport rotary valve 200 should not be so limited, as the invention can be utilized in other fluid flow applications.

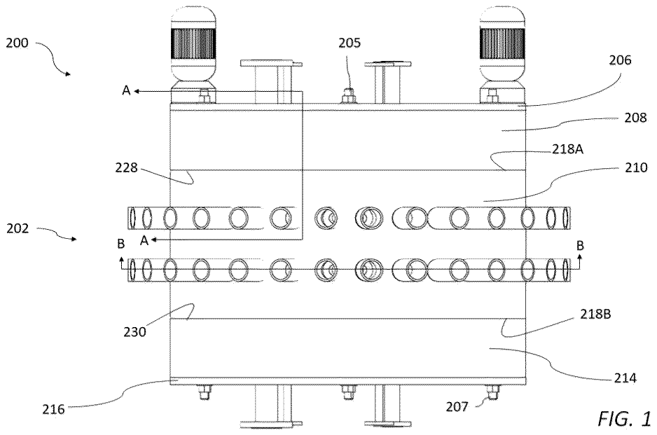

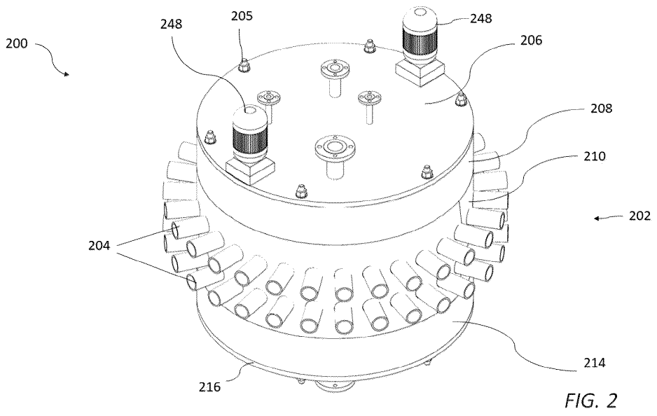

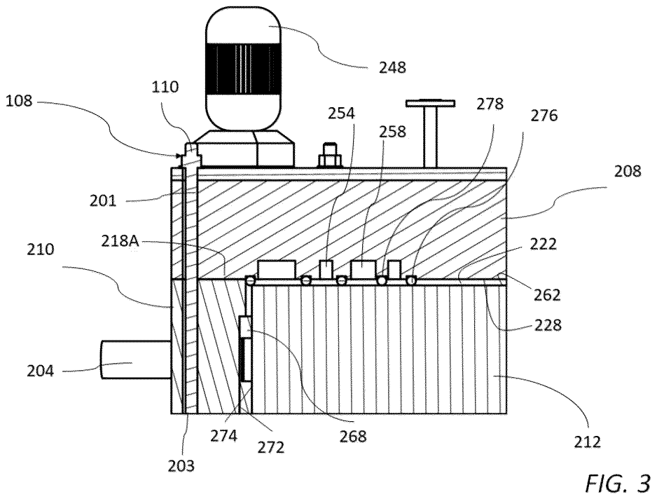

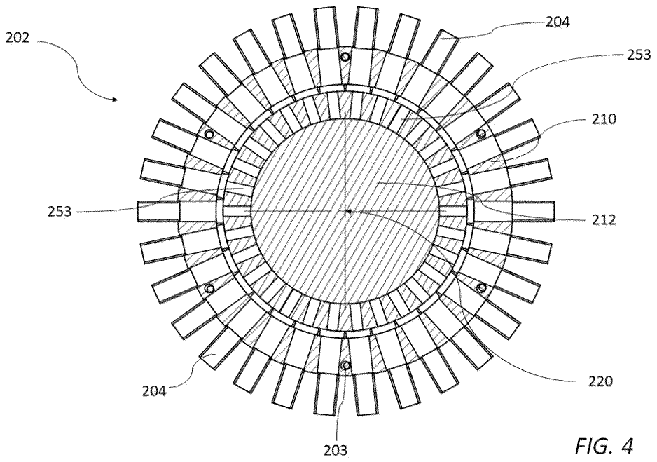

As illustrated in FIGS. 1 through 4, the multiport rotary valve 200 comprises a valve body 202 that is fluidly connected via distribution ports 204 to a plurality of external vessels (e.g., ion exchange or adsorption and desorption columns or beds) (not shown) for process fluid distribution and transport. The adsorbent beds or columns are arranged into process zones, each containing an adsorbent or resin (e.g., a lithium-or mineral-selective adsorbent or ion-exchange resin). Distribution of process fluids through the multiport rotary valve 200 is conducted via internal porting of distribution channels 253 within the valve body 202 before flowing to the columns or vessels from the distribution ports 204 in predetermined process sequences.

The valve body 202 of the multiport rotary valve 200 includes an upper deflection plate 206, an upper closure disc 208, a body or housing ring 210, a process disc 212, a lower closure disc 214, and a lower deflection plate 216. The housing ring 210 has opposing generally planar axial or open ends 218A/218B and is configured to surround the perimeter of the process disc 212. The housing ring 210, along with the upper and lower closure discs 208 and 214, defines an internal valve chamber 222. The process disc 212 is seated within the internal valve chamber 222 and is rotatable about a central axis 220. The process disc 212 can be a unitary construction or be constructed from multiple process discs and materials stacked coaxially, sealed, and connected within the housing ring 210. The upper closure disc 208, the process disc 212, and the lower closure disc 214 are coaxially aligned and axially spaced along the central axis 220.

The housing ring 210 defines end openings 218A/218B with the upper closure disc 208 and the lower closure disc 214 secured thereto, respectively. The upper deflection plate 206, the upper closure disc 208, the lower closure disc 214, the lower deflection plate 216, and/or the housing ring 210 can be flanged, threaded, or otherwise configured to match that of the mating connection. A plurality of axially aligned fastener openings 203 are provided to receive a compression or tensioning rod 201 disposed through axially aligned fastener openings 203 in the valve body 202 to secure the upper deflection plate 206, the upper closure disc 208, the lower closure disc 214, and the lower deflection plate 216 in sealing engagement to the respective end openings 218A/218B of the housing ring 210, and thereby compressing the process disc 212 within the housing ring 210. The upper deflection plate 206 and the lower deflection plate 216 distribute the compressive load from the tensioning rods 201 to the upper and lower closure discs 208/214 and the housing ring 210, thereby sealing the valve body 202 and constraining the process disc 212. Additionally, the process disc 212 and the internal valve chamber 222 of the housing ring 210 can be conically shaped (e.g., cone frustum shaped; however, other geometries may be used) such that the vertical compressive forces are translated into semi-horizontal compressive forces that engage the housing ring 210.

The process disc 212 is seated within the internal valve chamber 222 of the housing ring 210 and rotates at a predetermined rate about the central axis 220 to direct the process fluid flow to and from the columns or vessels in predetermined process sequences. The process disc 212 rotation is driven by one of several possible external motors, gearboxes, and internal gearing arrangements (e.g., gearmotor 248, which can be affixed to the upper deflection plate 206).

A feedstock stream is fluidly sent to influent passageways 254 in the upper closure disc 208 and influent passageways (not shown/mirror image of the influent passageways 254 in the upper closure disc 208) in the lower closure disc 214, respectively extending through the upper closure disc 208 and the lower closure disc 214. A product stream is fluidly sent to effluent passageways 258 in the upper closure disc 208 and effluent passageways (not shown/mirror image of the effluent passageways 258 in the upper closure disc 208) in the lower closure disc 214, which respectively extend through the upper closure disc 208 and the lower closure disc 214. The influent passageways 254 and the effluent passageways 258 in the upper closure disc 208 and the influent passageways and the effluent passageways in the lower closure disc 214 are fluidly connected to one or more distribution channels 253 on or in the process disc 212. The distribution channels 253 are open to an upper sealing surface 262 and a lower sealing surface (not shown/mirror image of the upper sealing surface 262) of the process disc 212 such that each distribution channel 253 corresponds to one of the influent passageways 254 in the upper closure disc 208 and/or one of the influent passageways in the lower closure disc 214 and one of the effluent passageways 258 in the upper closure disc 208 and/or one of the effluent passageways in the lower closure disc 214, which correspond to a particular process zone and is sealed against the other zones using concentric internal seals or seal assemblies 276 in the upper sealing surface 262 or the lower sealing surface (not shown/mirror image of the upper sealing surface 262). The distribution channels 253, the influent passageways 254 in the upper closure disc 208, the influent passageways in the lower closure disc 214, the effluent passageways 258 in the upper closure disc 208, and the effluent passageways in the lower closure disc 214 are respectively aligned during the rotation of the process disc 212 due to the concentric orientation of the influent passageways 254 in the upper closure disc 208 and the influent passageways in the lower closure disc 214 and the effluent passageways 258 in the upper closure disc 208 and the effluent passageways in the lower closure disc 214 and the distribution channels 253.

Internal porting of the distribution channels 253 within the process disc 212 distributes the process fluid from distribution ports 204 in the housing ring 210 to and from the columns or vessels arranged into process zones in predetermined process sequences. Upon return from the columns or vessels, the process fluid is either further distributed through additional process zones or fluidly sent from the effluent passageways 258 in the upper closure disc 208 and effluent passageways in the lower closure disc 214 to an external tank or vessel (not shown).

Based on the material construction of the process disc 212, the multiport rotary valve 200 is subject to fluid leakage if the spaces between the housing ring 210 and/or the upper and lower closure discs 206/214 and the process disc 212 are not properly sealed, especially during DLE applications. Further, the distribution channels 253, influent passageways 254 in the upper closure disc 208 and influent passageways in the lower closure disc 214, and effluent passageways 258 in the upper closure disc 208 and effluent passageways in the lower closure disc 214 may carry several different process fluids, and the proximity of the various process fluids within the valve body 202 and process disc 212 presents potential leak paths, thus requiring sealing engagement.

Accordingly, the process disc 212 and the housing ring 210 are sealed by one or more annular seals or sealing assemblies 268 to minimize process fluid leakage between the process disc 212 and the distribution ports 204 in the housing ring 210. The seal assembly(s) 268 can be carried within seal grooves 270 on a sidewall sealing surface 272 of the housing ring 210 and/or a sidewall sealing surface 274 of the process disc 212.

In addition to sealing engagement with the housing ring 210, the process disc 212 is sealed with respect to the upper closure disc 208 and the lower closure disc 214 by the internal seals or seal assemblies 276. The seal assemblies 276 can be carried within concentric seal grooves 278 on the upper sealing surface 262 and the lower sealing surface of the process disc 212 and/or the lower sealing surface 228 of the upper closure disc 208 and the upper sealing surface 230 of the lower closure disc 214. The seal assemblies 276 minimize process fluid leakage between influent passageways 254 in the upper closure disc 208 and influent passageways in the lower closure disc 214 and effluent passageways 258 in the upper closure disc 208 and effluent passageways in the lower closure disc 214 in the interface between the upper and lower closure discs 208 and 214 and the process disc 212.

In order to achieve better sealing and to mitigate long-term damage during operating conditions, the valve tightening assembly 100 includes a linear or rotary actuator assembly 106 and a force or weight sensor (e.g., strain gauge load cell, capacitive load cell, pneumatic load cell, hydraulic load cell, piezoelectric load cell), load washer, or other similar instrumentation 108 to measure the tension of the tightening assembly 100 and thus correlated to a compression force of the valve body 202. The valve tightening assembly 100 allows a predetermined amount of tension to be maintained on the valve body 202 during fluctuations in ambient and environmental temperatures, as well as operating fluid temperatures. The valve tightening assembly 100 engages the compression or tensioning rod 201 disposed through axially aligned fastener openings 203 in the valve body 202. Each actuator assembly 106 is configured about the corresponding tensioning rod 201.

An upper end and a lower end of the tensioning rod 201 are respectively connected to a first or upper fastener 205 and a second or lower fastener 207 to secure the upper deflection plate 206, the upper closure disc 208, the lower closure disc 214, and the lower deflection plate 216 in sealing engagement to the respective end openings 218A/218B of the housing ring 210, and thereby compressing the process disc 212 within the housing ring 210 of the valve body 202. The first fastener 205 is positioned around the tensioning rod 201 and against the upper deflection plate 206 of the valve body 202, thereby preventing upward movement of the valve body 202. The second fastener 207 is positioned about the tensioning rod 201 and against a lower end 116 of the actuator assembly 106, such that downward movement of the actuator assembly 106 is prevented. Optionally, a spacer 118 is positioned between the first fastener 205 and the valve body 202, between the second fastener 207 and the actuator assembly 106, or both.

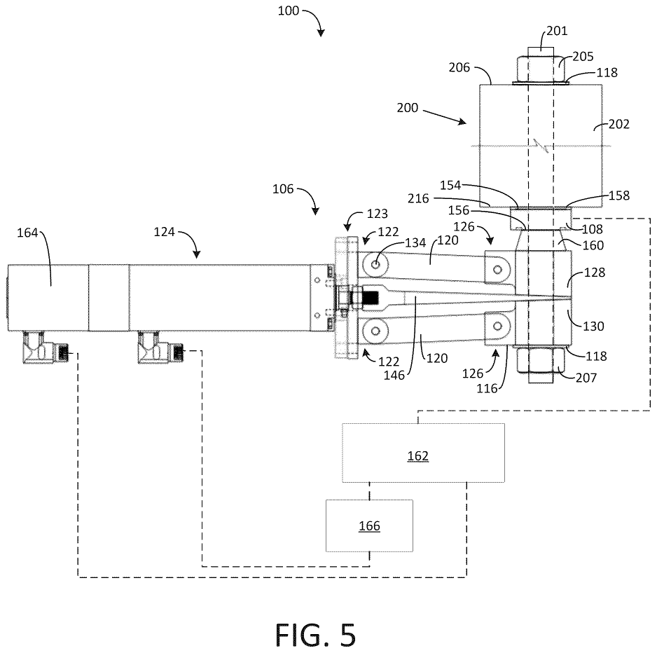

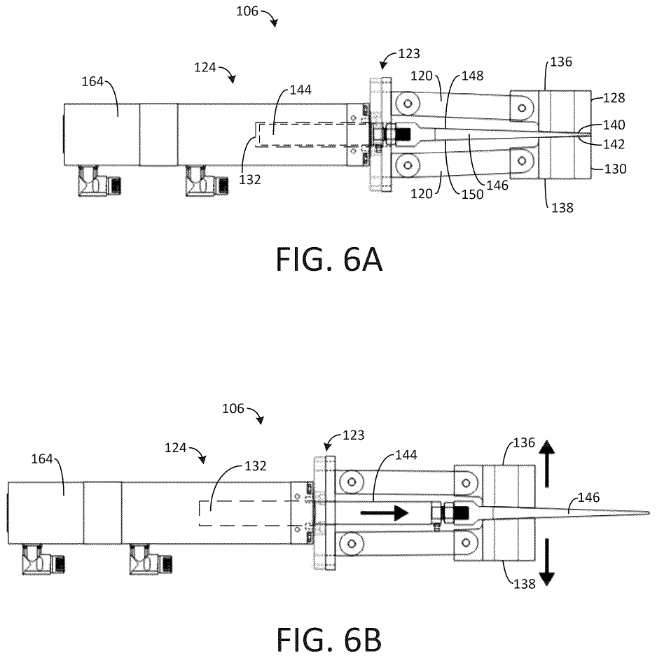

As exemplified in FIGS. 5 through 7, the actuator assembly 106 is a linear actuator assembly that includes two arms 120, where each arm 120 is attached at a first end 122 to an actuator mounting bracket 123, which is attached to a linear actuator body 124, and at an opposite second end 126 to a wedge block 128, 130. The linear actuator assembly 106 includes an actuator channel 132 within the linear actuator body 124, as shown in the partial cutaway view of FIGS. 6A and 6B. It will be appreciated that a longitudinal axis of symmetry extends through the middle of the actuator channel 132. As used in this disclosure, a reference to “longitudinal” will refer to a direction or axis that is parallel or co-linear with the central longitudinal axis extending through the actuator channel 132. A reference to a radial direction or radial axis will be understood to be in a direction that is substantially orthogonal to the central longitudinal axis. When describing features of the linear actuator assembly 106, a reference to an inner/interior feature or inward direction refers to something radially toward the longitudinal axis. In contrast, an outer/exterior feature or outward direction refers to something radially away from the longitudinal axis.

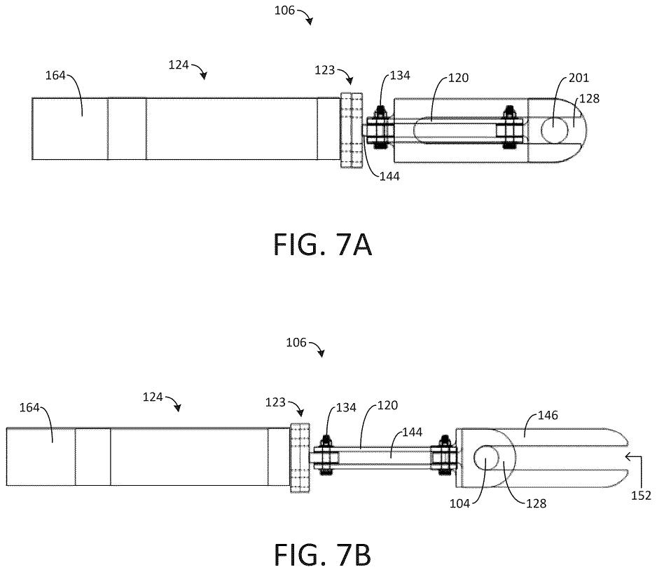

As illustrated in FIGS. 7A and 7B, each of the two arms 120 is connected to the actuator mounting bracket 123 at a pivot joint 134. On the second end 126 of each arm 120, the wedge blocks 128, 130 are configured to encircle the tensioning rod 201. Turning to FIGS. 5 through 6, each wedge block 128, 130 has an outer edge 136, 138 that faces away from the central longitudinal axis and an inner edge 140, 142 that faces toward the central longitudinal axis. In one embodiment, the outer edge 136 of the upper (or first) wedge block 128 is approximately parallel to the outer edge 138 of the lower (or second) wedge block 130, while the inner edge 140, 142 for each of the wedge blocks 128, 130 is angled inward in the direction away from the actuator channel 132.

The linear actuator assembly 106 also includes an actuator shaft 144 that is sized for partial or complete receipt within the actuator channel 132. One end of the actuator shaft 144 is attached to a tapered central wedge 146, which extends between the arms 120 and the wedge blocks 128, 130. The central wedge 146 has an angled upper surface 148 that corresponds to the angle of the inner edge 140 of the upper wedge block 128. Similarly, an angled lower surface 150 of the central wedge 146 corresponds to the angle of the inner edge 142 of the lower wedge block 130. The surfaces 148, 150, and edges 140, 142 of the wedges may be precision-machined and custom-polished to reduce friction and increase efficiency. The actuator shaft 144 is configured to perform linear movements along the central longitudinal axis, extending from the actuator channel 132. As illustrated in FIGS. 7A and 7B, the central wedge 146 may include a fastener channel 152 with a width that is the same or greater than the diameter of the tensioning rod 201. The fastener channel 152 enables the actuator shaft 144 to move away from the actuator channel 132 without becoming impeded by the tensioning rod 201.

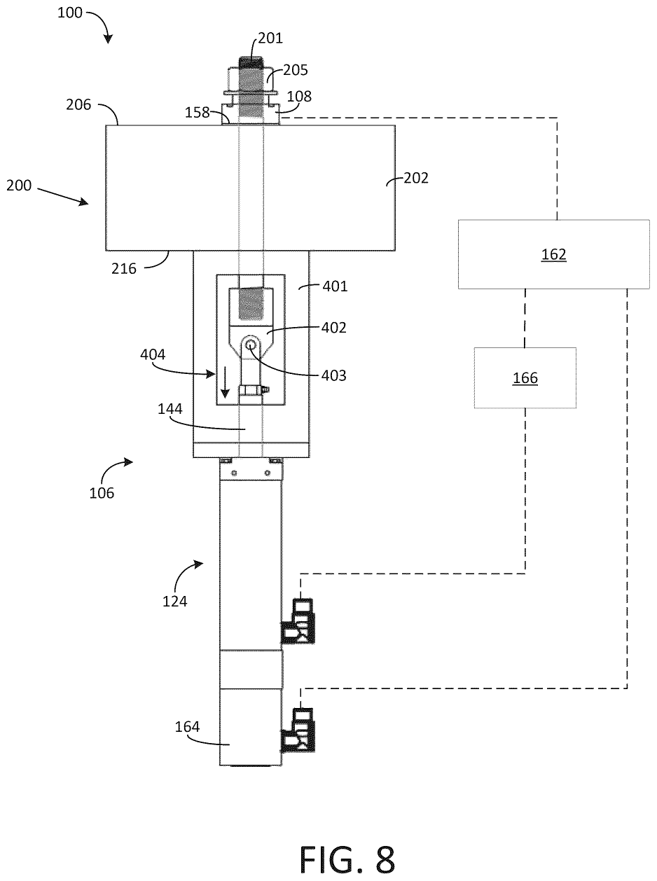

Turning now to FIG. 8, the valve tightening assembly 100 includes the linear actuator assembly 106 and the load cell 108. The valve tightening assembly 100 further includes the first (upper) fastener 205 and a hollow cylindrical fixture 401, which captures the valve body 202, the load cell 108, and the linear actuator assembly 106 about the tensioning rod 201. As illustrated, the first fastener 205 is positioned about the tensioning rod 201 and against the upper deflection plate 206 of the valve body 202, thus preventing upward movement of the valve body 202. The hollow cylindrical fixture 401 is positioned about the tensioning rod 201 and against the lower deflection plate 216 of the valve body 202, such that retraction of the linear actuator shaft 144 creates a compressive force on the valve body 202. The linear actuator assembly 106 may be attached to the hollow cylindrical fixture 401.

The linear actuator shaft 144 is directly attached to the tensioning rod 201. By non-limiting example, this can be accomplished by attaching a threaded adapter 402 to the linear actuator shaft 144 via a pinned connection 403. The threaded adapter 402 is then attached to the tensioning rod 201. As the linear actuator shaft 144 retracts, a clamping force is exerted on the valve body 202. The clamping force is created by the tensioning rod 201 pulling the valve body 202 towards the hollow cylindrical fixture. As the linear actuator shaft 144 is extended, the clamping force upon the valve body 202 is reduced. The hollow cylindrical fixture 401 may be opened by an operator via a cylindrical fixture window 404, allowing for access to the linear actuator shaft 144, the threaded adapter 402, and the pinned connection 403.

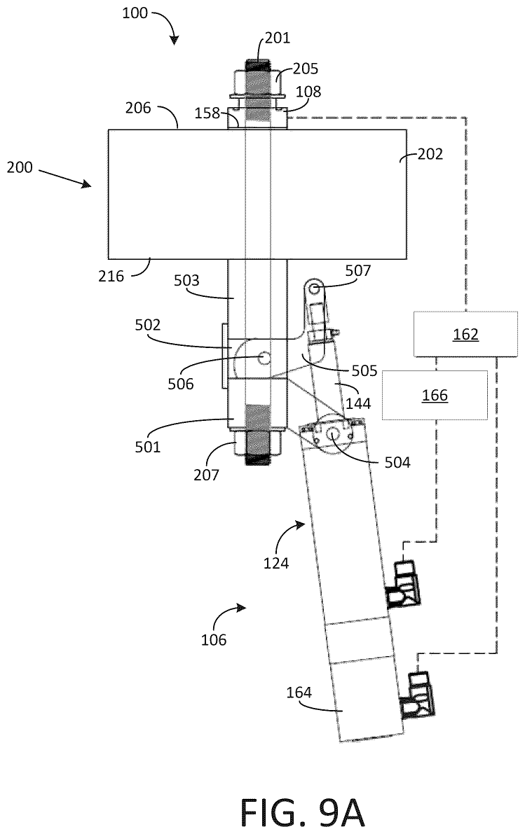

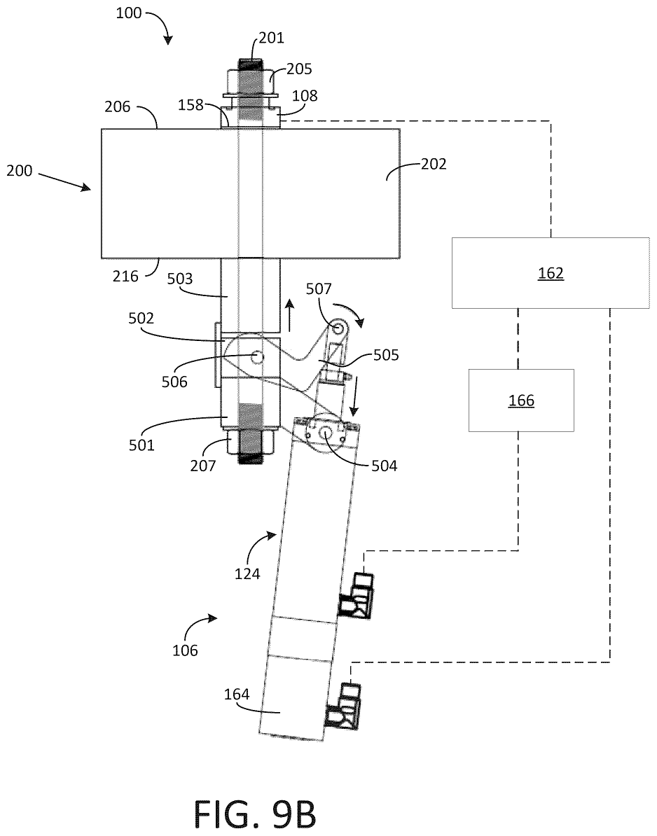

As shown in FIGS. 9A and 9B, the valve tightening assembly 100 includes the linear actuator assembly 106 and the load cell 108. The valve tightening assembly 100 further includes the first (upper) fastener 205, a lower fixture block 501 on the tensioning rod 201, an upper fixture block 502 on the tensioning rod 201, a spacer 503 above the upper fixture block 502, the load cell 108, and the linear actuator assembly 106 about the tensioning rod 201. More particularly, the first fastener 205 is positioned about the tensioning rod 201 and against the upper deflection plate 206 of the valve body 202, thus preventing upward movement of the valve body 202.

The spacer 503 is positioned above the upper fixture block 502 and against the lower deflection plate 216 of the valve body 202. The linear actuator assembly 106 is attached to the lower fixture block 501 to allow rotational movement of the linear actuator assembly 106 about the mounting point 504 (e.g., trunnion mount). At least two cam arms 505 are attached to the upper fixture block 502 by fasteners 506, allowing rotation of the cam arms 505 about the fasteners 506. Additionally, the cam arms 505 are attached to the linear actuator shaft 144 by a pinned connection 507.

To provide a clamping force upon the valve body 202, the linear actuator shaft 144 is retracted, thus rotating the cam arms 505 about the fasteners 506. As the cam arms 505 are rotated, separation occurs between the upper fixture block 502 and the spacer 503, pushing the spacer against the valve body 202, thereby imparting a clamping force onto the valve body 202. This embodiment enables force multiplication through lever action, allowing a smaller linear actuator to impart the same clamping force as other embodiments.

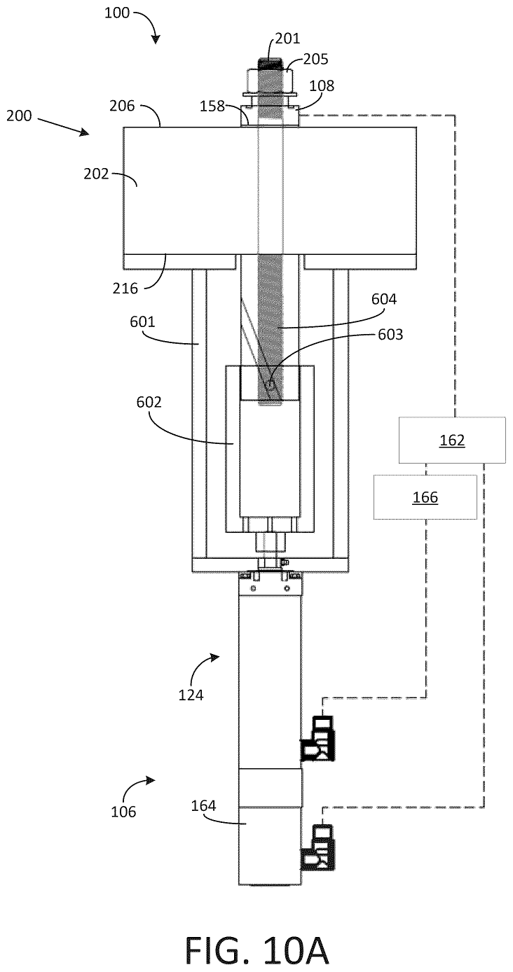

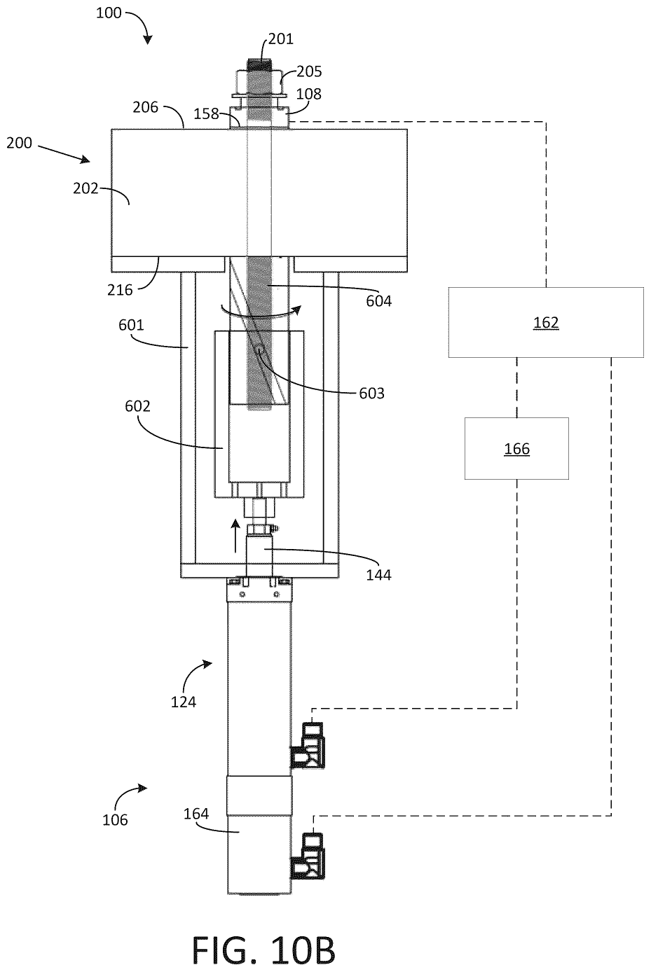

In another embodiment, as shown in FIGS. 10A and 10B, the valve tightening assembly 100 comprises the linear actuator assembly 106 and a load cell 108. The valve tightening assembly 100 further includes the first (upper) fastener 205 and a fixture 601, which capture the valve body 202, the load cell 108, a hollow cylindrical fixture 602 containing at least two internal pins 603, an inner cylindrical fixture 604 that contains external grooves, which is threaded onto the tensioning rod 201, and the linear actuator assembly 106 about the tensioning rod 201. More particularly, the first fastener 205 is positioned about the tensioning rod 201 and against the upper deflection plate 206 of the valve body 202, thus preventing upward movement of the valve body 202. The linear actuator assembly 106 is attached to the fixture 601 (e.g., by bolts). The fixture 601 is secured to the lower deflection plate 216 of the valve body 202. The hollow cylindrical fixture 602 is attached to the linear actuator shaft 144. The internal pins 603 of the hollow cylindrical fixture move in the machined grooves on the exterior of the inner cylindrical fixture 604.

As the linear actuator shaft 144 extends, the internal pins 603 force the inner cylindrical fixture 604 to rotate about the threads of the tensioning rod 201. As the inner cylindrical fixture 604 rotates, it tightens onto the tensioning rod 201, pushing against and imparting a clamping force onto the valve body 202. Furthermore, the valve tightening assembly 100 may utilize a ringed lip instead of internal pins 603 to ride within the exterior grooves of the inner cylindrical fixture 604, thereby causing the inner cylindrical fixture 604 to rotate about the tensioning rod 201.

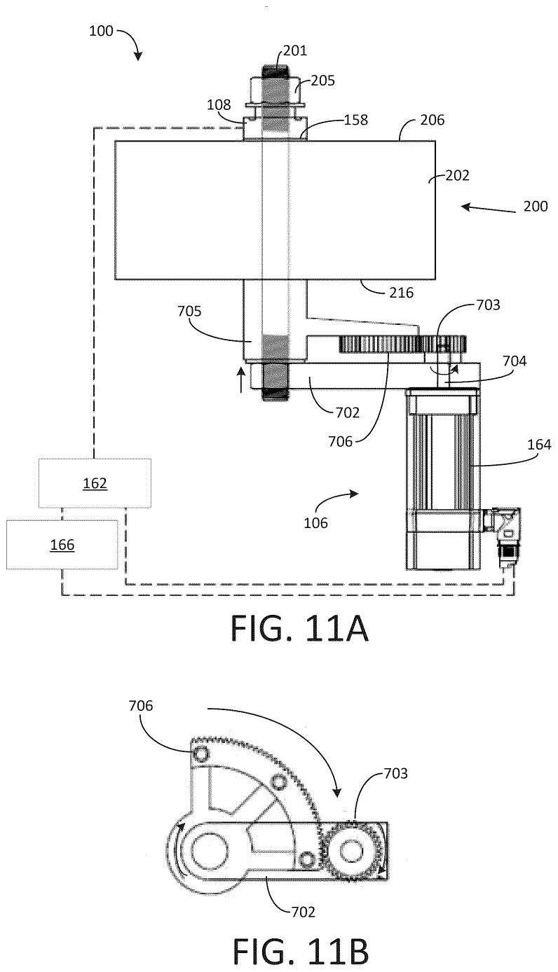

Referring now to FIGS. 11A and 11B, the valve tightening assembly 100 includes a rotary actuator assembly 106 and the load cell 108. The valve tightening assembly 100 further includes the first (upper) fastener 205 and an arm 702 threaded onto the tensioning rod 201, which capture the valve body 202, the load cell 108, a pinion gear 703 attached to a motor shaft 704 of the rotary actuator assembly 106, an upper fixture block 705 on the tensioning rod 201, a curved rack 706 mounted to the upper fixture block 705, and the rotary actuator assembly 106 about the tensioning rod 201. The first fastener 205 is positioned about the tensioning rod 201 and against the upper deflection plate 206 of the valve body 202, thus preventing upward movement of the valve body 202.

The rotary actuator assembly 106 causes the motor shaft 704 to rotate, thereby spinning the pinion gear 703. Spinning the pinion gear 703 causes the rotary actuator assembly 106 to rotate about the tensioning rod 201. As the rotary actuator assembly 106 rotates, the arm 702 tightens onto the threads on the tensioning rod 201, thereby pushing the arm 702 and the upper fixture block 705 towards the valve body 202 and imparting a clamping force on the valve body 202. The gearing ratio between the pinion gear 703 and the curved rack 706 may be adjusted, as well as the arm 702 length, thereby allowing for the minimization of the size and power requirements for the rotary actuator assembly 106. Additionally, adjusting the gear ratio between the pinion gear 703 and the curved rack 706, as well as the arm 702 length, allows for customizing the maximum torque applied by the rotary actuator assembly 106. One with ordinary skill in the art would recognize that the arm 702 can be caused to rotate about the tensioning rod 201 by hydraulic, mechanical, or electrical means (e.g., utilizing a hydraulic actuator to rotate the arm 702 or utilizing an electric motor to rotate the motor shaft 704).

The load cell 108 is positioned between the actuator assembly 106 and the valve body 202, producing one or more signals indicative of the clamping force applied to the valve body 202 at a given time. It will be appreciated that the load cell 108 may produce signals continuously, at a preset time interval (e.g., 30 seconds, 10 minutes, daily), or on command (e.g., in response to an input from an operator). As exemplified in FIGS. 5 through 7, the load cell 108 contacts the lower deflection plate 216 of the valve body 202 at an upper end 154 and contacts the upper wedge block 128 at a lower end 156. In another embodiment, a first spacer 158 is positioned between the load cell 108 and the lower deflection plate 216 of the valve body 202. In yet another embodiment, a second spacer 160 is positioned between the load cell 108 and the actuator assembly 106. The sizes of the first and second spacers 158, 160 may be customized based on the size of the valve body 202, the load cell 108, the tensioning rod 201, and the actuator assembly 106. For example, as depicted in FIG. 5, the second spacer 160 may be larger (e.g., wider) or smaller than the first spacer 158. As exemplified in FIGS. 8 through 11, a lower end of the load cell 108 contacts the upper deflection plate 206 of the valve body 202 and is secured to the tensioning rod 201 by the first fastener 205. The first spacer 158 can be positioned between the load cell 108 and the upper deflection plate 206 of the valve body 202.

The valve tightening assembly 100 also includes a computer system 162 that is configured to receive the signals produced by the load cell 108 and to produce instructions related to the movement of the actuator shaft 144 or the rotation of the motor shaft 704 based on the received signals. More particularly, the computer system 162 produces instructions for the valve tightening assembly 100 to apply a static or dynamic clamping force to the valve body 202. In one embodiment, the computer system 162 stores the signals received from the load cell 108 for long-term data collection of the clamping forces applied to the valve body 202. Data acquired from the load cell 108 over time can be analyzed for environmental and process anomalies as well as predictive maintenance insights. The computer system 162 may include a display interface (not shown) that allows an operator to view information on clamping force readings from the load cell 108, set points, and controls. In one non-limiting embodiment, the computer system 162 is a programmable logic controller. It will be appreciated that a single computer system 162 may be used with multiple actuator assemblies 106 and load cells 108. It will further be appreciated that the computer system 162 may activate one or all actuator assemblies 106 individually or simultaneously.

The computer system 162 produces instructions by comparing the signals received from the load cell 108 to a predetermined setpoint, which reflects the desired clamping force for the corresponding valve body 202. The clamping forces required for a given valve body are determined on a case-by-case basis. In one embodiment, the predetermined setpoint is 10,000 lbs. or greater.

When the signals produced by the load cell 108 indicate an applied clamping force that is lower than the predetermined setpoint (i.e., when the valve body 202 is fastened too loosely), the computer system 162 produces instructions to extend the actuator shaft 144 or to rotate the motor shaft 704.

For the valve tightening assembly 100 shown in FIGS. 5 through 7, as the actuator shaft 144 extends, the central wedge 146 forces the wedge blocks 128, 130 outward by pushing them apart. The arms 120 are configured to swivel outward to accommodate this vertical expansion of the wedge blocks 128, 130, thus maintaining repeatable gapping between the actuator mounting bracket 123 and the wedge blocks 128, 130. Because the first fastener 205 and the second fastener 207 restrict movement along the tensioning rod 201, as the wedge blocks 128, 130 are pushed vertically against the load cell 108 and the second fastener 207, the valve body 202 becomes more compressed between the first fastener 205 and the load cell 108. In this manner, the longitudinal force of the actuator shaft 144 is converted to a vertical clamping force on the valve body 202. On the other hand, when signals produced by the load cell 108 reflect an applied clamping force that exceeds the predetermined setpoint (i.e., when the valve body 202 is fastened too tightly), the computer system 162 generates an instruction to retract the actuator shaft 144 into the actuator channel 132. As the actuator shaft 144 retracts, the wedge blocks 128, 130 move inward, thereby reducing the vertical clamping force applied to the valve body 202.

For the valve tightening assembly 100 shown in FIG. 8, as the actuator shaft 144 retracts, the tensioning rod 201, attached to the actuator shaft 144 by the threaded adapter 402 and pinned connection 403, is pulled towards the hollow cylindrical fixture 401. Because the first fastener 205 and the hollow cylindrical fixture 401 restrict movement along the tensioning rod 201, as the actuator shaft 144 is retracted, the valve body 202 becomes more compressed between the first fastener 205 and hollow cylindrical fixture 401. In this manner, the longitudinal force of the actuator shaft 144 is converted to a vertical clamping force on the valve body 202. On the other hand, when signals produced by the load cell 108 reflect an applied clamping force that is higher than the predetermined setpoint (i.e., when the valve body 202 is fastened too tightly), the computer system 162 produces an instruction to the motion controller 166 to extend the actuator shaft 144 away from the actuator channel 132. As the actuator shaft 144 extends, the tensioning rod 201 moves away from the hollow cylindrical fixture 401, thereby reducing the vertical clamping force applied to the valve body 202.

For the valve tightening assembly 100 shown in FIGS. 9A and 9B, as the actuator shaft 144 retracts, the cam arms 505 rotate about the fasteners 506. The cam arms 505 are configured to push the spacer 503 towards the valve body 202. As the cam arms 505 rotate, the spacer 503 is pushed away from the upper fixture block 502 and towards the valve body 202. Because the first fastener 205 and a second (lower) fastener 207 restrict movement along the tensioning rod 201, as the spacer 503 is pushed vertically against the valve body 202, the valve body 202 becomes more compressed between the first fastener 205 and the spacer 503. In this manner, the longitudinal force of the actuator shaft 144 is converted to a vertical clamping force on the valve body 202. On the other hand, when signals produced by the load cell 108 reflect an applied clamping force that is higher than the predetermined setpoint (i.e., when the valve body 202 is fastened too tightly), the computer system 162 produces an instruction to the motion controller 166 to extend the actuator shaft 144 away from the actuator channel 132. As the actuator shaft 144 extends, the cam arms 505 rotate, allowing the spacer 503 to move towards the upper fixture block 502, thereby reducing the vertical clamping force applied to the valve body 202.

For the valve tightening assembly 100 shown in FIGS. 10A and 10B, as the actuator shaft 144 extends, the internal pins 603 of the hollow cylindrical fixture 602 ride in the machined grooves on the exterior of the inner cylindrical fixture 604. The inner cylindrical fixture 604 is configured to rotate about the threads of the tensioning rod 201 as the internal pins 603 travel through the machined grooves on the exterior of the inner cylindrical fixture 604. Thus, transforming the rotational motion of the inner cylindrical fixture 604 about the tensioning rod 201 into a vertical motion towards or away from the valve body 202, depending on the direction of rotation of the inner cylindrical fixture 604. Therefore, as the actuator shaft 144 extends, the internal pins 603 rotate the hollow cylindrical fixture 604 towards the valve body 202. Because the first fastener 205 and the fixture 601 restrict movement along the tensioning rod 201, the hollow cylindrical fixture 604 pushes vertically against the valve body 202, and the valve body 202 becomes more compressed between the first fastener 205 and the hollow cylindrical fixture 604. In this manner, the longitudinal force of the actuator shaft 144 is converted to a vertical clamping force on the valve body 202. On the other hand, when signals produced by the load cell 108 reflect an applied clamping force that is higher than the predetermined setpoint (i.e., when the valve body 202 is fastened too tightly), the computer system 162 produces an instruction to the motion controller 166 to retract the actuator shaft 144 into the actuator channel 132. As the actuator shaft 144 retracts, the internal pins 603 rotate the hollow cylindrical fixture 604 away from the valve body 202, thereby reducing the vertical clamping force applied to the valve body 202.

For the valve tightening assembly 100 shown in FIGS. 11A and 11B, when the signals produced by the load cell 108 indicate an applied clamping force that is lower than the predetermined setpoint (i.e., when the valve body 202 is fastened too loosely), the computer system 162 produces instructions to the motion controller 166 to rotate the motor shaft 704 of the actuator assembly 106. As the motor shaft 704 rotates, the pinion gear 703 travels across the curved rack 706, forcing the arm 702 to rotate about the threaded tensioning rod 201. The arm 702 and tensioning rod 201 are configured so that rotation of the arm 702 causes the arm 702 to travel vertically towards or away from the valve body 202. Because the first fastener 205 restricts movement along the tensioning rod 201, as the arm 702 travels vertically towards the valve body 202, the arm forces the upper fixture block 705 to push onto the valve body 202, thereby compressing the valve body 202 between the first fastener 205 and the upper fixture block 705. In this manner, the rotational force of the motor shaft 704 is converted to a vertical clamping force on the valve body 202. On the other hand, when signals produced by the load cell 108 reflect an applied clamping force that is higher than the predetermined setpoint (i.e., when the valve body 202 is fastened too tightly), the computer system 162 produces an instruction to the motion controller 166 to rotate the motor shaft 704 in the opposite direction. As the motor shaft 704 rotates, the arm 702 moves away from the valve body 202, thereby reducing the vertical clamping force applied to the valve body 202.

The degree to which the computer system 162 instructs the actuator shaft 144 to extend from or retract into the actuator channel 132 (or the motor shaft 704 to rotate) depends on the difference between the predetermined setpoint and the applied clamping forces, as reflected in the signals from the load cell 108. In one embodiment, the load cell 108 continues to produce signals, and the computer system 162 continues to receive these signals, as the actuator shaft 144 actively extends or retracts or the motor shaft 704 actively rotates. The computer system 162 continuously compares these received signals to the predetermined setpoint and produces an instruction to stop the linear movement of the actuator shaft 144 or the rotation of the motor shaft 704 once the received signal indicates that the applied clamping force matches the predetermined setpoint.

In another embodiment, the computer system 162 uses the difference between the predetermined setpoint and the applied clamping force to calculate an initial displacement for the actuator shaft 144 or an initial rotation for the motor shaft 704 that will resolve the inconsistency. The computer system 162 produces an instruction for the actuator shaft 144 to perform the initial displacement (either extending from or retracting into the actuator channel 132) or for the motor shaft 704 (either rotating clockwise or counterclockwise). Once the actuator shaft 144 has performed the initial displacement or the motor shaft 704 has performed the initial rotation, the computer system 162 receives new signals from the load cell 108 and again compares the applied clamping force to the predetermined setpoint. If a difference remains, the computer system 162 calculates a subsequent displacement or rotation to resolve the inconsistency and produces an instruction for the actuator shaft 144 or motor shaft 704 to be moved or rotated accordingly. This cycle continues until the signals received from the load cell 108 indicate that the desired applied clamping force has been achieved. The computer system 162 can also generate instructions to move or rotate by comparing the signals received from the positioning feedback of the actuator shaft 144 or the motor shaft 704 with a baseline location.

The movement of the actuator shaft 144 or the motor shaft 704 may be powered by one or more mechanical actuators 164 that convert an electrical, pneumatic, or hydraulic input into energy. Suitable mechanical actuators 164 include servo motors, pneumatic actuators, hydraulic actuators, or other linear or rotary actuators. The mechanical actuator(s) 164 may be activated by a motion controller 166, which receives instructions from the computer system 162 to perform one or more linear movements of the actuator shaft 144 or rotational movement of the motor shaft 704. In response to these instructions, the controller 166 initiates the mechanical actuator(s) 164 and dictates the direction of the longitudinal force for the actuator shaft 144 or of the rotational force for the motor shaft 704. In the case of a pneumatic or hydraulic actuator arrangement for the mechanical actuator(s) 164, the movements of the actuator shaft 144 or the rotation of the motor shaft 704 may be controlled via one or more separate pneumatic or hydraulic controllers located outside the actuator assembly 106. Each controller 166 may include a control unit (e.g., pump), distribution valve(s), connecting hoses or tubing, a fluid reservoir, and control architecture.

The valve tightening assembly 100 optionally includes a brake that is configured to hold the actuator shaft 144 in a fixed position with reference to the actuator channel 132. For example, the computer system 162 may produce instructions to engage or disengage the brake based on whether the applied clamping force is, respectively, equal to or different from the predetermined setpoint. In the event of power loss, the brake prevents the linear actuator assembly 106 from retracting into the actuator channel 132, thereby maintaining the applied clamping force against the valve body 202. When the mechanical actuator 164 consists of one or more servo motors, the brake is inherent to the servo design. In contrast, for a pneumatic or hydraulic mechanical actuator 164, the brake is controlled by maintaining consistent inlet or outlet pressure on the actuator assembly 106.

This feedback mechanism allows for active monitoring of the applied clamping force on the valve body 202. Dynamic monitoring eliminates inconsistencies that occur when operators perform manual adjustments. The valve tightening assembly 100 provides a consistent external clamping force for the valve body 202, even as internal valve forces change due to process and external conditions (e.g., temperature and pressure differentials), and compensates for any eccentricities in the valve machinery (e.g., in an internal rotating process disc or external housing ring). The valve tightening assembly 100 thereby minimizes the risk of internal crossflow and external leakage of the valve body 202, excess wear on the sealing and mating surfaces of the valve, and strain on the valve's motor(s) and gearbox(es).

It will be appreciated that the valve tightening assembly 100 may include multiple actuator assemblies 106 and load cells 108, which correspond to the number of tensioning rods 201 that are monitored to the valve body 202. Each actuator assembly 106 allows for independent control of tightening for its respective valve body 202. In embodiments with multiple actuator assemblies 106, differential tightening may be performed on the valve bodies 202 individually, in segments, or as a whole, as needed.

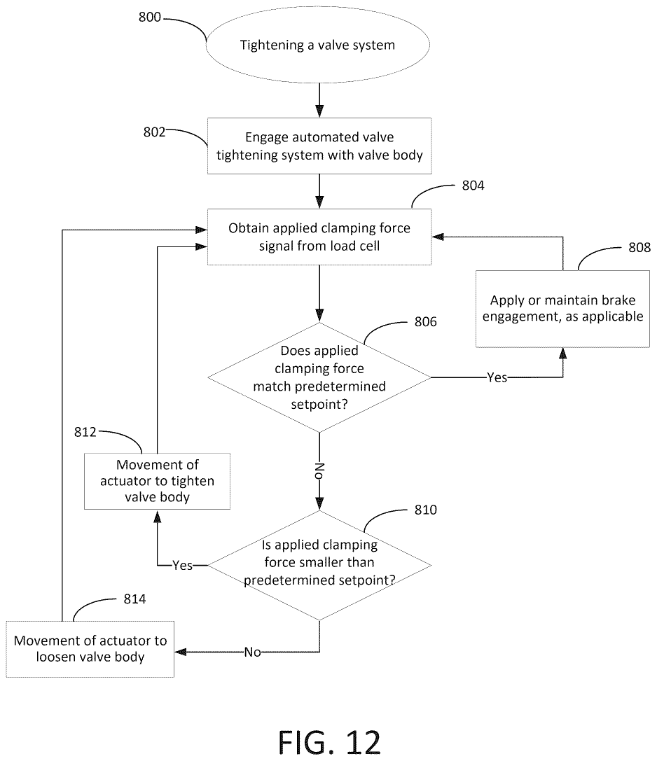

Turning to FIG. 12, a process 800 for tightening the valve is outlined. Step 802 involves engaging the valve tightening assembly 100 with a tensioning rod 201 of the valve body 202. To engage the valve tightening assembly 100, the actuator assembly 106 is placed in a fully retracted state or a predetermined minimum engaged state (see, e.g., FIG. 6A). The valve body 202 is captured against the load cell 108 using the first fastener 205, which is tightened to bring the valve body 202 gap to a set and measured dimension. The actuator shaft 144 is then slowly extended from the actuator channel 132 or the motor shaft is rotated until the desired clamping force (i.e., the predetermined setpoint) is achieved. In one embodiment of step 802, the computer system 162 activates the controller 166 to perform the initial extension of the actuator shaft 144 or rotation of the motor shaft 704, disables the controller 166 when the predetermined setpoint is reached, and then actuates the brake of the actuator assembly 106 to provide a static clamping force.

Once the desired clamping force is achieved, the load cell 108 measures the clamping forces over time and relays signals related to the clamping force measurements to the computer system 162 at step 804. At step 806, the computer system 162 evaluates whether the applied clamping force related through the load cell 108 signals matches the predetermined setpoint. If yes, the computer system 162 provides instructions to apply the brake, if not already engaged, at step 808. If the brake is already engaged, the valve tightening assembly 100 maintains the brake engagement. If the computer system 162 instead determines that the applied clamping force does not match the predetermined setpoint, the computer system 162 further evaluates the difference between the applied clamping force and the predetermined setpoint at step 810. If the applied clamping force is smaller than the predetermined setpoint, the computer system 162 instructs the actuator assembly 106 to extend or rotate at step 812, thereby tightening the valve body 202. On the other hand, if the applied clamping force exceeds the predetermined setpoint, the computer system 162 instructs the actuator assembly 106 to retract or counter-rotate at step 814, thereby loosening the valve body 202. In some embodiments, steps 812 and 814 involve the computer system 162 engaging the controller 166 to control one or more mechanical actuators 164, which power the movement or rotation of the actuator assembly 106.

After adjustments are made to the clamping force at either step 812 or step 814, the process 800 is returned to step 804 to obtain a subsequent applied clamping force signal from the load cell 108, which is again compared to the predetermined setpoint at step 806.

Accordingly, the valve tightening assembly 100 may be utilized to achieve and maintain a predetermined valve body gap, which can be verified visually or using one or more measurement devices such as feeler gauges, laser distance sensors, or other instrumentation. The measurement device(s) can be in communication with a control system, such as described below, to provide feedback for control (e.g., automated and/or real-time) of the valve tightening assembly 100. The valve tightening assembly 100 may also be utilized to achieve proper sealing of the various internal sealing surfaces within the valve housing/body 102, which can be verified using test ports and controlled by a control system.

As noted above, the valve tightening assembly and process, and the associated devices, sensors, and instrumentation, may be implemented in a computer control system using hardware, software, firmware, tangible computer-readable media having instructions stored thereon, or a combination thereof, and may be implemented in one or more computer systems or other processing systems.

If programmable logic is used, it may execute on a commercially available processing platform or a special-purpose device. One of ordinary skill in the art may appreciate that embodiments of the disclosed subject matter can be practiced with various computer control system configurations, including multi-core multi-processor systems, minicomputers, mainframe computers, computers linked or clustered with distributed functions, as well as pervasive or miniature computers that may be embedded into virtually any device.

Various embodiments of the inventions may be implemented in terms of this example control system. After reading this description, it will become apparent to a person skilled in the relevant art how to implement one or more of the inventions using other control systems, computer systems, and/or computer architectures. Although operations may be described as a sequential process, some operations can be performed in parallel, concurrently, and/or in a distributed environment, with program code stored locally or remotely for access by single-or multi-processor machines. In addition, in some embodiments, the order of operations may be rearranged without departing from the spirit of the disclosed subject matter.

The processor device may be a special-purpose or general-purpose processor device, or it may be a cloud service in which the processor device resides in the cloud. As will be appreciated by persons skilled in the relevant art, the processor device may also be a single processor in a multi-core/multi-processor system, such as a system operating alone or in a cluster of computing devices, or a server farm. The processor device is connected to a communication infrastructure, for example, a bus, message queue, network, or multi-core message-passing scheme.

The computer system also includes a main memory, for example, random access memory (RAM), and may also include a secondary memory. The secondary memory may include, for example, a hard disk drive or a removable storage drive. The removable storage drive may include a floppy disk drive, a magnetic tape drive, an optical disk drive, flash memory, a Universal Serial Bus (USB) drive, or a similar device. The removable storage drive reads from and/or writes to a removable storage unit in a well-known manner. The removable storage unit may include a floppy disk, magnetic tape, optical disk, etc., which is read by and written to by the removable storage drive. As will be appreciated by persons skilled in the relevant art, the removable storage unit includes a computer usable storage medium having stored therein computer software and/or data.

The computer system (optionally) includes a display interface (which can include input and output devices, such as keyboards and mice) that forwards graphics, text, and other data from the communication infrastructure (or from a frame buffer not shown) for display on a display unit.

In alternative implementations, the secondary memory may include other similar means for allowing computer programs or other instructions to be loaded into the computer system. Such means may include, for example, the removable storage unit and an interface. Examples of such means may include a program cartridge and cartridge interface (such as that found in video game devices), a removable memory chip (such as an EPROM, PROM, or Flash memory) and associated socket, and other removable storage units and interfaces which allow software and data to be transferred from the removable storage unit to the computer system.

The computer system may also include a communication interface. The communication interface allows software and data to be transferred between the computer system and external devices. The communication interface may include a modem, a network interface (such as an Ethernet card), a communication port, a PCMCIA slot, or a similar device. Software and data transferred via the communication interface may be in the form of signals, which may be electronic, electromagnetic, optical, or other signals capable of being received by the communication interface. These signals may be provided to the communication interface via a communication path. A communication path carries signals, such as those over a network in a distributed computing environment, for example, an intranet or the Internet. It may be implemented using wire or cable, fiber optics, a phone line, a cellular phone link, an RF link, or other communication channels.

The description of the invention is intended to be read in connection with the accompanying drawings, which are to be considered part of the entire written description of this invention. In the description, relative terms such as “front,” “rear,” “lower,” “upper,” “horizontal,” “vertical,” “above,” “below,” “up,” “down,” “top” and “bottom” as well as derivatives thereof (e.g., “horizontally,” “downwardly,” “upwardly” etc.) should be construed to refer to the orientation as then described or as shown in the drawings under discussion. These relative terms are for convenience of description and do not require that the machine be constructed or the process to be operated in a particular orientation. Terms, such as “connected,” “connecting,” “attached,” “attaching,” “join” and “joining” are used interchangeably and refer to one structure or surface being secured to another structure or surface or integrally fabricated in one piece.

The preceding detailed description of exemplary embodiments of the invention makes reference to the accompanying drawings, which show the exemplary embodiment by way of illustration. While these exemplary embodiments are described in sufficient detail to enable those skilled in the art to practice the invention, it should be understood that other embodiments may be realized and that logical and mechanical changes may be made without departing from the spirit and scope of the invention. For example, the steps recited in any of the method or process claims may be executed in any order and are not limited to the order presented. Thus, the preceding detailed description is presented for purposes of illustration only and not of limitation, and the scope of the invention is defined by the preceding description and with respect to the attached claims.

What is claimed is:

1. A valve tightening assembly for a multiport rotary valve, comprising:
a valve body having a tensioning assembly configured to apply an axial compressive force to the valve body, the tensioning assembly comprises at least one tensioning rod axially extending through the valve body;
a force or weight sensor disposed about the tensioning rod and positioned adjacent to the valve body, the force or weight sensor producing a signal indicative of a clamping force applied to the valve body;
an actuator assembly operatively coupled to the tensioning rod and configured to vary the clamping force applied to the valve body; and
a control system operatively coupled to the force or weight sensor and to the actuator assembly, the control system configured to:
compare the signal from the force or weight sensor to a predetermined setpoint; and
command the actuator assembly to adjust the clamping force when the signal deviates from the predetermined setpoint.

2. The assembly of claim 1, wherein the actuator assembly comprises a linear actuator assembly or a rotary actuator assembly having electric, hydraulic, or pneumatic actuation.

3. The assembly of claim 2, wherein the linear actuator assembly comprises a linear actuator body having an actuator channel, an actuator shaft configured for linear movement to and from the actuator channel, and a mechanism for converting linear movement of the actuator shaft into a change in clamping force on the valve body.

4. The assembly of claim 3, wherein the mechanism comprises a central wedge attached to the actuator shaft, a first wedge block positioned above the central wedge, and a second wedge block positioned below the central wedge.

5. The assembly of claim 3, wherein the mechanism is attached to the tensioning rod such that extension of the actuator shaft creates the clamping force on the valve body.

6. The assembly of claim 3, wherein the mechanism comprises cam arms attached to the actuator shaft such that retraction of the actuator shaft rotates the cam arms to create the clamping force on the valve body.

7. The assembly of claim 3, wherein the mechanism comprises a fixture attached to the actuator shaft such that extension of the actuator shaft rotates the fixture about the tensioning rod to create the clamping force of the valve body.

8. The assembly of claim 3, further comprising a brake configured to hold the actuator shaft in place.

9. The assembly of claim 8, wherein the control system produces instructions to engage the brake when the signals produced by the force or weight sensor match the predetermined setpoint.

10. The assembly of claim 2, wherein the rotary actuator assembly comprises a motor, a motor shaft extending from the motor, a pinion gear fixed to the motor shaft, an arm attached to the tensioning rod, and a curved rack secured to the tensioning rod and meshing with the pinion gear, wherein rotation of the motor shaft affects axial movement of the arm relative to the tensioning rod to vary the clamping force.

11. The assembly of claim 1, wherein the valve body comprises a housing ring defining an internal valve chamber, an upper closure disc and a lower closure disc secured to opposing axial ends of the housing ring, and a process disc rotatably received within the internal valve chamber.

12. The assembly of claim 11, wherein the multiport rotary valve further comprises an annular seal or sealing assembly constructed of a low-friction polymeric material and disposed between a sidewall of the housing ring and a periphery of the process disc, and a plurality of concentric seals or sealing assemblies constructed of a low-friction polymeric material and disposed between axially confronting sealing surfaces of the process disc and the upper and lower closure discs.

13. The assembly of claim 1, wherein the control system is configured to selectively adjust the clamping force applied to or maintained on the valve body in response to real-time feedback obtained from the force or weight sensor during startup, operation, and/or cooldown of the multiport rotary valve.

14. The assembly of claim 1, wherein the force or weight sensor comprises one or more strain gauge load cells, capacitive load cells, pneumatic load cells, hydraulic load cells, piezoelectric load cells, inductive load cells, magnetostrictive load cells, optical fiber load cells, load washers, or a combination thereof.

15. The assembly of claim 1 further comprising a position feedback device.

16. The assembly of claim 15, wherein the position feedback device comprises one or more encoders, linear potentiometers, linear variable differential transformers, or a combination thereof.

17. A process for tightening a multiport rotary valve, comprising the steps of:
engaging a valve tightening assembly with a valve body of the multiport rotary valve, wherein the valve tightening assembly comprises:
a force or weight sensor disposed about the tensioning rod and positioned adjacent to the valve body, the force or weight sensor producing a signal indicative of a clamping force applied to the valve body;
an actuator assembly operatively coupled to the tensioning rod and configured to vary the clamping force applied to the valve body; and
a control system operatively coupled to the force or weight sensor and to the actuator assembly;
obtaining signals from the force or weight sensor, wherein the signals represent a clamping force applied to the valve body;
comparing the clamping force to a predetermined setpoint; and
adjusting the clamping force to match the predetermined setpoint.

18. The process of claim 17, wherein the step of adjusting the clamping force further comprises moving a shaft of the actuator assembly.

19. The process of claim 17 further comprising the step of engaging a brake to maintain the clamping force.

20. The process of claim 17, wherein the adjusting step further comprises selectively adjusting the clamping force applied to or maintained on the valve body in response to real-time feedback obtained from the force or weight sensor during startup, operation, and/or cooldown of the multiport rotary valve.
